(19) United States
(12) Patent Application Publication
(10) Pub. No.: US 2012/0079271 A1
(43) Pub. Date: Mar. 29, 2012

(54) METHOD AND APPARATUS FOR WIRELESS DEVICE AUTHENTICATION AND ASSOCIATION

(76) Inventors: Carlos CORDEIRO, Portland, OR (US); Solomon B. Trainin, Haifa (IL)

(21) Appl. No.: 12/889,674

(22) Filed: Sep. 24, 2010

(51) Int. Cl. H04L 29/06; H04L 9/00

(52) U.S. Cl. 713/166; 726/3

(57) ABSTRACT

Methods and devices controlling association and/or authentication of wireless devices. At a first wireless device which is unassociated and unauthenticated with a second device, a state variable representing the second device may be stored, where the variable indicates that the second device is unassociated and unauthenticated with the first device. A message may be received from the second device requesting to associate. The variable may be changed to indicate that the second device is associated and unauthenticated. A message may be received from the second device requesting to authenticate, and the state variable may be changed to indicate that the second device is authenticated. In some cases, a wireless device stores variable(s) representing a second device, the variables indicating that the second device is unassociated and unauthenticated, receives a message from the second device requesting authentication, and changes a state variable to indicate that the second device is authenticated.

### FIELD OF THE INVENTION

The present application relates generally to communication among devices in wireless networks, and in particular to association and authentication of wireless devices.

### BACKGROUND

Devices in a wireless network using the IEEE 802.11 architecture may communicate with the assistance of a central station such as an access point (AP), or directly, one to the other, without any assistance from the central station. The first arrangement may be called infrastructure mode and the second may be called ad hoc mode, or peer-to-peer service. Work has been initiated to amend the 802.11 standard for mmWave (e.g., 60 GHz) usages, which are of different nature than traditional 802.11 usages. mmWave is a radio frequency band having a wavelength of ten to one millimeter or from 30 to 300 Gigahertz in frequency. Compared to lower bands of radiation, terrestrial radio signals in this band are prone to atmospheric attenuation, making them difficult to use over long distances.

An IEEE 802.11 ad hoc network may be referred to as an independent basic service set (IBSS). In such an ad hoc network, there may be no AP, and the network may include only two wireless devices, such as stations (STAs) communicating with each other.

A personal basic service set (PBSS) is an ad hoc network where one STA assumes the role of the PBSS central point (PCP). The PCP provides the basic timing for the PBSS through mmWave Beacon and Announce frames as well as allocation of service periods and contention-based periods.

The existing authentication/association procedure between two STAs in a wireless network using the IEEE 802.11 architecture may include two phases. In phase 1, the STA may perform authentication and association with another peer STA or other device. FIG. 1 depicts a set of states for an authentication and association procedure in an existing system. FIG. 1 depicts one example of phase 1 which may be applicable to, for example, infrastructure basic service set (BSS) networks and IBSS networks. Referring to FIG. 1, a STA or other device may be in state 1, where the device unauthenticated and unassociated with respect to another device, such as a STA. If authentication is successful, the devices may move to a state such as state 2, where the devices are authenticated and unassociated with each other. If association is successful, the devices may move to a state such as state 3, where the devices are authenticated and associated with each other. After this process, which requires a certain amount of processing cost and data storage cost, a further authentication may be performed.

In phase 2, the device may perform a robust secure network authentication (RSNA) protocol with the other device. The process may re-authenticate the device and in addition may set up the security keys needed for the communication between the devices. In such a system there may be duplication in tasks performed as part of phase 1 and phase 2. In particular, the authentication process in phase 1 may be redundant as another authentication is performed in phase 2 as part of the secure key establishment of RSNA. In some systems, the redundant authentication in phase 1 may be performed, for example, to have a network be backward-compatible with legacy devices or other devices.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 depicts a set of states and transitions for an authentication and association procedure in an existing system;

FIG. 2A is a block diagram of a network according an embodiment of the present invention;

FIG. 2B depicts a device according to an embodiment of the present invention;

FIG. 3 depicts a set of states and transitions for two or more devices communicating with each other according to one embodiment of the present invention;

FIG. 4 is a flowchart of a method according to an embodiment of the present invention; and

FIG. 5 is a flowchart of a method according to an embodiment of the present invention.

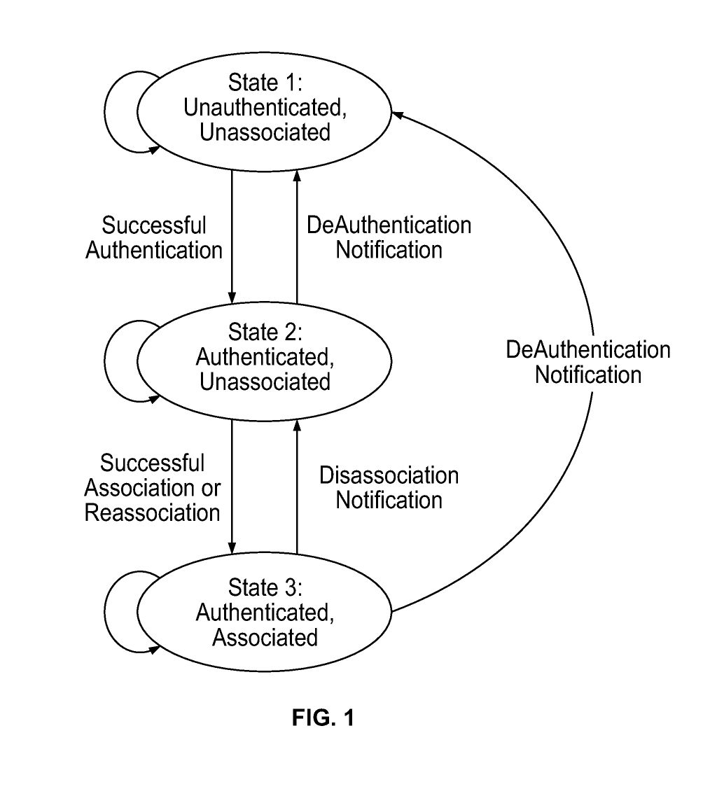

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention. Further, aspects of specific embodiments may be used with other embodiments described herein.

Unless specifically stated otherwise, as apparent from the following discussions, it is appreciated that throughout the specification discussions utilizing terms such as “processing,” “computing,” “calculating,” “determining,” or the like, refer to the action and/or processes of a computer and/or computing system and/or medium access controller (MAC) and/or communication processor, or similar electronic computing device, that manipulates and/or transforms data represented as physical, such as electronic, quantities within the computing system's registers and/or memories into other data similarly represented as physical quantities within the computing system's memories, registers or other such information storage, transmission or the like.

Embodiments of the present invention may allow for integrating into one procedure association and authentication, and may eliminate redundant or multiple authentications. The RSNA or other authentication and the association procedures may be merged into a single state machine with the same number of states as a prior art state machine. Devices may associate, and then authenticate, without re-authentication. Devices may associate first and then authenticate, as opposed to authenticating and then associating, as in the prior art. In one embodiment, a device keeping track of the state of another device, and performing authentication with and associating with another device, may require less overhead, both computationally and storage, than with prior art techniques. Further, embodiments of the present invention may provide an authentication and/or association procedure that is more integrated, faster and more efficient than prior procedures. Embodiments of the present invention may be particularly applicable in frequency bands or systems where no legacy 802.11 devices operate, and thus more burdensome prior procedures need not be used and no backward compatibility may be required. Embodiments of the present invention may be used in other situations, where legacy devices operate. In some embodiments a device may become authenticated without passing through an association procedure, again saving computational and other overhead.

Embodiments of the present invention may be used in a variety of applications. Although the present invention is not limited in this respect, the circuits and techniques disclosed herein may be used in many apparatuses such as communication devices of a wireless or radio communication system. The communication devices and networks intended to be included within the scope of the present invention include, by way of example only, STAs or other devices that are part of a BSS, mobile stations, base stations and APs of radio systems such as, for example wireless local area network (WLAN) which also may be referred as WiFi, a wireless metropolitan area network (WMAN) which also may be referred as WiMAX, a wireless personal area network (WPAN) using, for example using Bluetooth™ protocols or Wireless Gigabit Alliance (WiGig) protocols, a BSS, a PBSS, an extended service set (ESS), an IBSS, a millimeter wave (mmWave) BSS or mmWave PBSS, PBSS central points or control points (PCPs), two-way radio transmitters, digital system transmitters, analog system transmitters, cellular radiotelephone transmitters, digital subscriber lines, LTE cellular systems and the like.

When used herein, an AP may be an entity that has a STA functionality and that provides access to distribution services, via the wireless medium (WM) for associated STAs. A WM may be the medium used to implement the transfer of data between physical layer (PHY) entities of a wireless network. A BSS may be, for example, a set STAs that have formed or are part of a network. Membership in a BSS does not imply that wireless communication with all other members of the BSS is possible. A STA may include a device that contains an IEEE 802.11-conformant MAC and PHY interface to the WM. A STA when used herein may include other wireless devices forming a network, using protocols other than IEEE 802.11 protocols, such as WiGig protocols.

In accordance with some aspects of the present invention, a network architecture and basic medium access mechanism in 60 GHz is based on time division multiple access (TDMA) as a channel access method. In TDMA, the channel schedule is sent by a PCP or AP to all STAs in the network. However, transmission in a BSS setting may use random access which does not require scheduling (e.g., schedule-free).

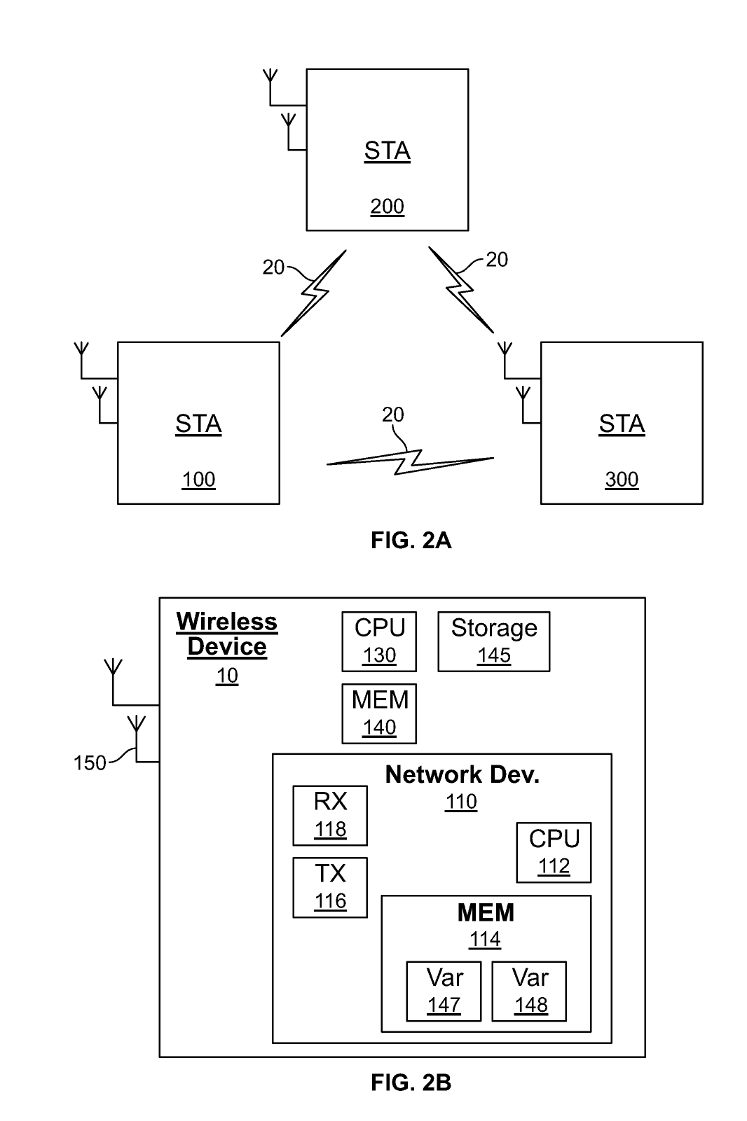

FIG. 2A is a block diagram of a network according an embodiment of the present invention. Wireless devices 100, 200 and 300 may communicate via communications links or channels 20 (e.g., using mmWave signals). Each wireless device 100 and 200 may be for example a STA, but may be another device, and in various embodiments wireless device 300 may be an AP or PCP. In other embodiments devices 100 and 200 may function as APs, PCPs, or other types of controllers. In other embodiments an AP or PCP need not be used.

FIG. 2B depicts a device according to an embodiment of the present invention. Each of devices 100, 200 and 300 (FIG. 2A) may be or include all or part of the components in device 10, or other components. Device 10 may include a network adapter 110, including a processor 112, a memory 114, a transmitter (TX) 116, and a receiver (RX) 118. Device 10 may include a processor 130, memory 140, long term storage device 145, and one or more antennas 150. Although each of memories 140 and 114 are depicted as different units, these memories can each be parts of the same unit, distributed units, virtual memory, etc. Typically processor 112 controls wireless communications, including the authentication and association procedures discussed herein, and processor 130 controls overall device functionality, such as personal computing applications or general tasks, game console or controller tasks, user interface tasks, operating system tasks, etc. In other embodiments, the functions of processor 112 and processor 130 may be different, each may take on the functions of the other, or the functions may be combined into one unit.

Network adapter 110 may be coupled to a communication channel 20 (FIG. 2A). Network adapter 110 may include components such as a WiFi chipsets, a WiGig chipset, a MAC controller, and network processors. Network adapter 110 may carry out all or part of the functionality of embodiments of the present invention, such as transmitting and receiving communications related to authentication and association (e.g., via TX 116 and RX 118), determining states to transition to, storing state variables (e.g., in memory 114), and other functionality. Network adapter 110 may implement, for example, a state machine to track and implement transitions of states corresponding to the association or authentication status of devices or processes, according to embodiments described herein. State variables stored may include one or more local association state variables 147 and one or more local security state variables 148. In alternate embodiments states may be stored in other forms, e.g., databases; however, when used herein state variables include such alternate forms of storage such as databases, memory locations, etc. While association state variables and security state variables are described as being separate entities in some embodiments, one state variable may include both security state and association state information; e.g., one state variable may include both security state variables and association state variables. Memory 114 may include other information regarding the local state of wireless devices, and other data used for wireless communication, such as encryption keys. All or part of the functionality of adapter 110 may be carried out by dedicated hardware units, and/or by processor 112, for example executing instructions or software stored in memory 114. In some embodiments, data discussed as being stored in memory 114 may be stored in memory 140 and/or long term storage device 145, and vice versa Likewise, functionality discussed as being carried out by processor 112 or network adapter 110 may be carried out by processor 130, and vice versa. Antenna 150 may include any antenna that is used for wireless communication, for example, dipole antennas, antenna arrays and the like, and may include multiple antennas.

Memory 140 and long term storage device 145 may store for example data to be transmitted or which has been received, other data, and instructions or code which when executed by a processor (e.g. processor 130) may perform functions described herein. Long term storage device 145 may include any suitable storage medium used with wireless devices for example, hard disks, flash memories, etc. Processor 130 and processor 112 may include more than one processor and may be and/or include, for example, controllers, central processing units (CPUs), MACs, PHY controllers, digital signal processor (DSPs), etc.

The devices of FIG. 2 may be various types of devices with various functionalities. For example, device 100 may be a monitor or display, and device 200 may be a video game controller allowing user input to device 300, which may be a video game console. Processor 130 may execute code or software for example stored in memory 140 to produce the functionality the devices, for example, the functionality of a monitor, video game console, and video game controller. The devices may communicate data such as user input (e.g. from the controller) and output (e.g. to the monitor). Devices 100, 200 and 300 may be or include other devices, such as personal computers, laptop computers, personal digital assistants, cellular telephones, cellular telephone or personal computer peripheral devices (e.g., headsets, input devices such as mice or keyboards), workstations, servers, and other devices. While three devices are shown, other numbers may be used.

The devices of FIG. 2 may form a network such as a PBSS or IBSS, but other network systems may be used. The devices may communicate in a peer-to-peer and ad hoc fashion, without the need for a dedicated device such as an AP. In such a network no device is permanently dedicated for a particular network function and all devices may perform the role of a content consumer, creator, or both. If the network shown in FIG. 2 uses directional devices (e.g., if the network is a 60 GHz network), Carrier Sense Multiple Access (CSMA) may not work well. In an embodiment of the present invention, a TDMA channel access is used as the basic access scheme instead of Carrier Sense Multiple Access With Collision Avoidance (CSMA/CA), and the authentication/association procedure may be tailored for TDMA access. In other applications of embodiments of the present invention, one of devices 100, 200 or 300 may be an AP or similar device, and an ad hoc or peer-to-peer network need not be used.

In an embodiment where devices 100 and 200 form an ad hoc network (e.g. a PBSS), one device (e.g., device 100 or 200) may act as a PCP or other control or central point. The PCP or other control or central point may provide basic timing for the PBSS via, e.g., mmWave Beacon and Announce frames as well as allocation of service periods and contention-based periods.

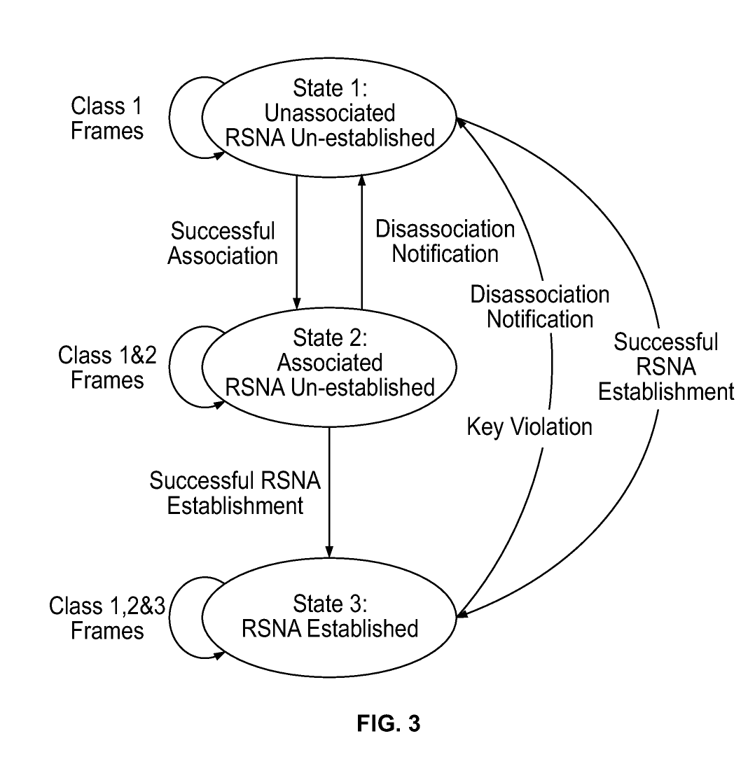

FIG. 3 depicts a set of states and transitions for two or more devices communicating with each other according to one embodiment of the present invention. Such states may be stored in state variables 147 and 148, e.g., in a combination of these variables held on one or more devices. A state machine may be implemented (e.g., in network adapter 110, processor 112, and memory 114) according to the states and transitions shown in FIG. 3. In state 1 (the initial, start state), device A may be unassociated with and have no secure connection with (e.g. be RSNA unestablished relative to) device B. In such a state only certain data, e.g., class 1 frames, may be exchanged between the two devices. Such a process may be more efficient and robust, since it can achieve, for example, the same level of security as prior art processes but with a reduced number of states and hence a reduced level of complexity.

The devices may transition from state 1 to state 2 if device A becomes associated with device B. The devices may transition from state 2 to state 1 if device A becomes unassociated with device B. In state 2, device A may be associated with and have no secure connection with (e.g. be RSNA unestablished relative to) device B. In such a state the type of data that may be exchanged between the two devices is less restricted, e.g., class 1 frames and class 2 frames may be exchanged.

The devices may transition from state 2 to state 3 if device A has a secure connection established with or is authenticated with device B (e.g. RSNA established) or if a process executing on device A (e.g., processor 130 executing code or instructions stored in memory 140) has a secure connection established with a process executing on device B. The devices may transition from state 3 to state 2 if device A or a process on device A becomes unauthenticated with device B or a process on device B. In state 3, device A may have a secure connection (e.g. be RSNA established) with device B. In such a state a less restricted set of frames, e.g., class 1, 2 and 3 frames, may be exchanged between the two devices. In this example, class 3 frames include more secure content than class 2 frames, and class 2 frames include frames with more functionality than class 1 frames. In state 3 (and in some embodiments to transfer to state 3), devices are not required to be associated with a central controller such as an AP, as is the case in the prior art. Similarly, to move to an authenticated state, devices are not required to be associated with a central controller such as an AP, as is the case in the prior art. In embodiments of the present invention, association can take place as part of an integrated procedure before authentication. Further, in contrast to the prior art, authentication may only be performed once, after association (if association takes place). The number of states, and the number of state transitions, required to become RSNA authenticated may be less than in the combined two-phase procedure that may be required in the prior art. Thus embodiments of the present invention may be more efficient and less complex. In other embodiments, other states and transitions may be implemented.

A wireless device such as a STA may determine which frame transmissions and receptions are permitted between itself and another device based on the state between itself and the other device. For example, if the state that exists between the two devices is state 1, then only class 1 frames shall be permitted to be transmitted and received. If the state between the two devices is state 2, then only class 1 and class 2 frames shall be permitted to be transmitted and received. If the state between the two devices is state 3, then class 1, 2 and 3 frames are permitted to be transmitted and received. Other types and levels of transmissions may be controlled.

The devices may transition directly from state 1 to state 3, without an association process (e.g., devices may transition from state 1 to state 3 directly without passing through state 2). Thus, in one embodiment, STAs or other devices may establish a secure communication link even in the absence of association. Device A or a process executing on device A may establish a secure connection with device B or a process executing on device B (e.g. establish RSNA). The devices may transition from state 3 to state 1 if device A or a process on device A becomes RSNA un-established with device B or a process on device B. The state to which the devices transition may depend, for example, on state variables.

The direct transition from state 1 to state 3 may allow a new behavior which is not allowed in the existing 802.11 process. When devices are operating according to the existing 802.11 protocols, a device that does not go through the association process (e.g., a STA in an IBSS) may permanently remain in state 1 (un-associated, un-authenticated). In such a situation the device may not be able to establish RSNA since it would always remain in state 1. In embodiments of the present invention, this restriction is no longer present. Embodiments of the present invention support peer-to-peer communication models such as may be required by a PBSS specification, where any STA should be allowed to transmit packets to another STA with or without association, and with or without RSNA being established.

Various events may cause a device to move from state 3 to state 2 or from state 2 to state 1. For example, devices may become disassociated or un-authenticated.

In one embodiment, each of devices 100, 200 and 300 may store, for each other device with which it communicates, an association local state variable 147 and a security local state variable 148. Thus each of devices 100, 200 and 300 may store multiple state variables—for example two for each device or process it is communicating with, or two for each MAC address related device or process it is communicating with. When used herein, if a state variable represents an association and/or authentication status of a device, this may include, in some embodiments, that the state variable represents an association/authentication status of a process being executed on that device, or the association/authentication status with respect to an identifier such as a MAC address maintained by that device. Each pair of devices communicating with each other thus may involve four state variables—two in each device. If device 300 is communicating with both device 100 and device 200, device 300 may maintain two state variables 147 and 148 representing device 100 for its communication with device 100 and two state variables 147 and 148 representing device 200 for its communication with device 200. In alternate embodiments the state of a communications link may be represented by other numbers of state variables, e.g., one state variable with three states (e.g., per FIG. 3).

Each state variable 147 and 148 may represent, for the device that maintains or stores it, that device's representation or knowledge of its communication link with the device that the state variable represents. State variables stored by a PCP/AP or other central control device may represent a client device A's association/authentication state relative to its PCP/AP; conversely, state variables stored by a client device A may represent device A's association/authentication state relative to its PCP/AP. In one embodiment each state variable 147 and 148 may represent, for example, that a device is unassociated and RSNA un-established with a second wireless device, that a device is associated and RSNA un-established with a second wireless device, that a device is associated and RSNA established with a second device, or that a device is unassociated and RSNA established with a second wireless device. While, as depicted in FIG. 3, one state is described as simply being authenticated or RSNA established, a state variable may be stored by devices while in the authenticated or RSNA established corresponding to an association state, and this variable may have meaning and use. This meaning may refer to the state of a device before transitioning to the authenticated or RSNA established state. For example, when devices transition out of the authenticated or RSNA established state, a transition may be to state 1 or state 2 based on the associated state variable. In one embodiment, each state variable 147 and 148 may be one bit, e.g., 1 or 0, each representing for example associated/unassociated or authenticated/unauthenticated, but other systems or codes to represent states may be used.

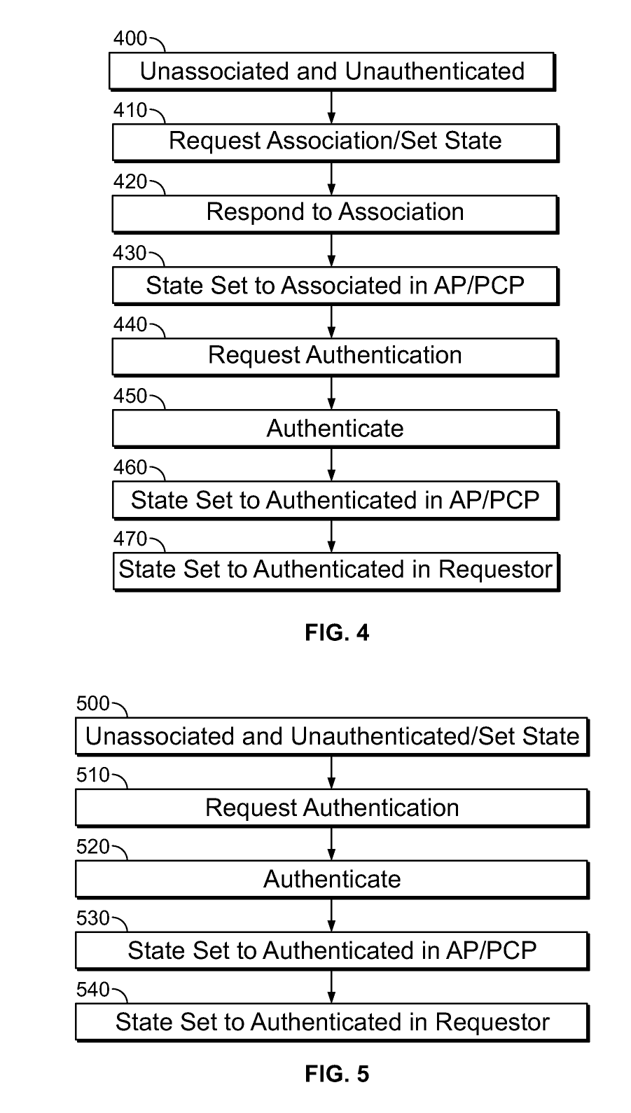

FIG. 4 is a flowchart of a method according to an embodiment of the present invention. In the embodiment showed in FIG. 4, association and authentication are performed as one integrated process. The operations shown in FIG. 4 may be performed by devices as shown in FIG. 2, but other devices and other data structures may be used, and other states and transitions may be used. For example, device 100 may wish to form an ad hoc network (e.g., a PBSS) with device 300, or may wish to join a network where device 300 functions as an AP or other central controller.

In some embodiments, association and/or authentication may be performed relative to, for example, a MAC address or other identifier. Thus, for example, a first device may associate with a second device. Then, for each MAC address possessed by or associated with the first device, the MAC address, or a process associated with the MAC address, may be authenticated with the second device. Therefore, multiple state machines may be maintained and operated, and multiple state variables may be maintained, for each MAC address or process on a device for which authentication is desired (in some embodiments the same may be done with respect to association). When used herein, performing association and/or authentication with respect to a device may include performing association and/or authentication with respect to a process, identifier or MAC address maintained by the device, and therefore multiple associations and/or authentications may be performed for each device. In some embodiments, one state variable may be maintained for a device to indicate whether the device is associated, and multiple state variables may be maintained (one for each process or MAC address) for that device regarding authentication. In other embodiments, multiple state variables may be maintained (one for each process or MAC address) for that device regarding authentication and also association.

In operation 400, a requesting or client device (e.g., wireless device or a STA such as device 100) or process (e.g., processor 130 executing code or instructions stored in memory 140) wishing to become associated and/or authenticated with another device or process may be unassociated and un-authenticated (e.g., is RSNA unestablished) with respect to the other device or process (e.g., a wireless device). The other device may be, for example, a STA such as device 300 (e.g., acting or capable of acting as a PCP), or an AP such as device 300 in an embodiment where device 300 is an AP. For example, the device may be in state 1 as shown in FIG. 3.

In such a state, to the extent either of the two devices keep or have kept a record of the state of the other device (e.g., using state variables), the state is unassociated/RSNA un-established. In such a state, a certain level of transmissions or packets (e.g., a low-security level such as class 1) may be exchanged between the devices, and higher security level packets (e.g., classes 2 and 3) may not be exchanged. In one embodiment, the requesting device may, before the time of sending an association request or message, create and store one or more state variables describing it with respect to the controller or central device, the state variable(s) recording the state as being unassociated and unauthenticated.

In operation 410, the requesting device may transmit or send an association request or message, e.g., a frame, to the controller or central device, or to a device about to become such a controller or central device. Such a transmission (as with other transmissions between devices) may be, e.g., a wireless transmission, and may be caused by or initiated by a processor or controller in the device. In alternate embodiments a requesting device may become associated with a device other than an AP or PCP, such as a STA acting not as a PCP. At this time, or soon after, the controller or central device may store, or set, one or more state variables representing the requesting device to indicate that the requesting device is associated and un-authenticated, e.g. with respect to the controller or central device. In some embodiments an association request may be sent for each process or MAC address for which an association is desired (typically at different times). In such a case, multiple state machines and multiple state variables may be maintained, both at the requesting device and at the controller or central device.

In operation 420, the controller or central device may receive the message from the requesting device requesting to associate with the controller and may transmit or send an association response transmission, e.g. as a frame, to the requesting device. This may be done in response to the association request, and in addition to further determinations, e.g., the controller or central device determining if it is appropriate to associate with the requesting device.

In operation 430, the controller or central device may set one or more state variables representing the requesting device to indicate that the requesting device is associated and un-authenticated (e.g., RSNA un-established). In some embodiments this corresponds with state 2 in FIG. 3. For example, a state variable stored within the controller or central device may be set or changed indicating that the requesting device is associated with the controller or central device, and a state variable stored within the controller or central device may be set or changed indicating that the requesting device (or a process in the requesting device) is un-authenticated with the controller or central device. In such a state, a certain level of transmissions or packets (e.g., a security level such as class 2 and also class 1) may be exchanged between the devices, but higher security level transmissions (e.g., class 3) may not be exchanged.

In operation 440, the requesting device may initiate a sequence of transmissions or messages to authenticate itself with the controller or central device. In one embodiment, authentication may be for each MAC address or other identifier or process possessed by or maintained by the requesting device. In such a case, multiple state machines and multiple state variables may be maintained, both at the requesting device and at the controller or central device. This authentication may involve several transmissions back and forth between the devices. For example, the four-way handshake may be used, which results in information used to construct keys, and keys themselves, being exchanged.

In some embodiments, association may be performed at a device level, while authentication may be performed at a process, identifier, or MAC address level. In such embodiments, additional state variables or state machines may be created at or around the time authentication is performed for additional processes, identifiers, or MAC addresses. Therefore, the state variable(s) may indicate whether a first process executed by the requesting device is unauthenticated or authenticated, and when the controller receives messages from the requesting device requesting to establish authentication regarding a second process, identifier or MAC address (e.g., executed by the requesting device) a second state variable may be established and set to indicate that the second process is authenticated with the controller. In one implementation one state machine and variable set is maintained separately for each process, identifier or MAC address a wireless device possesses. In another implementation a single state variable may be maintained for association for a device, and multiple state variables and machines (e.g., one for each MAC address) may be maintained for authentication. For example, a device may move separately from state 2 or state 1 to state 3 for each MAC address it possesses.

In operation 450, the requesting device, process, or MAC address may be authenticated (e.g., RSNA established) with the controller or central device. This may include a confirmation, encryption key, or other transmission being sent by the controller or central device to the requesting device, and this may be done in response to the authentication request, and in addition to further determinations, e.g., the controller or central device determining if it is appropriate to authenticate the requesting device.

In operation 460, the controller or central device may set one or more state variables representing the requesting device to indicate that the device is authenticated. In some embodiments this corresponds with state 3 in FIG. 3. A state variable stored within the controller or central device may be set or changed indicating that the requesting device (or a process in the requesting device) is authenticated with the controller or central device. In some embodiments, an association variable is maintained, for example for use in determining to which state to return if de-authentication occurs.

In operation 470, the requesting device may similarly set or change one or more state variables representing the requesting device to indicate that the requesting device (or a process, identifier, or MAC address) is authenticated (e.g., RSNA established). In such a state, a higher level (e.g., a security level such as classes 1-3) of transmissions or packets may be exchanged between the devices.

Other operations or series of operations may be used.

In one embodiment, if a device such as a non-PCP STA wants to establish an RSNA or other authentication with a PCP or other device without association, it can directly initiate an authentication with the other device, possibly followed by a process such as a 4-Way Handshake. One difference between this procedure and prior art procedures (such as may be used with an IBSS) may be that only one RSNA authentication and one 4-Way Handshake are performed between two STAs. If both devices initiate an authentication at or approximately at the same time, conflicts may be resolved in several manners. For example, the RSNA setup initiated by the STA with the lower MAC address may be carried through, and the RSNA setup initiated by the STA with the higher MAC address may be terminated.

FIG. 5 is a flowchart of a method according to an embodiment of the present invention. In the embodiment shown in FIG. 5, devices or processes may transition directly from being unassociated and un-authenticated to being authenticated (e.g., RSNA established) without passing through a state, such as state 2, where a device or process is associated but un-authenticated. This may occur, for example, in devices with limited capabilities such as mobile phones, handheld devices, etc., which may try to skip association, or in peer-to-peer networks. This may occur in other situations as well. As discussed above, in some embodiments authentication may be performed for each process, MAC address or other identifier for which an authentication is desired (at different times).

In operation 500, a requesting device (e.g., a STA such as device 100) or process wishing to become authenticated with another device or process may be unassociated and un-authenticated (e.g., is RSNA unestablished) with the other device. The other device may be, for example, a STA such as device 300 (e.g., acting or capable of acting as a PCP), or an AP such as device 300 in an embodiment where device 300 is an AP. Such a state may correspond to state 1 of FIG. 3. To the extent either of the two devices keep a record of the state of the other device (e.g., using state variables), the state may be described as unassociated and RSNA un-established. In one embodiment, the requesting device may, before the time of sending an authentication request or message, create and store one or more state variables describing it with respect to the controller or central device, the state variable(s) recording the state as being unassociated and unauthenticated.

In operation 510, the requesting device or process may initiate a sequence of transmissions or messages to authenticate itself with the controller or central device. For example, RSNA may be requested.

In operation 520, the requesting device or process may be authenticated (e.g., RSNA established) with the controller or central device. This may include a confirmation, encryption key, or other transmission being sent by the controller or central device to the requesting device, and this may be done in response to the authentication request, and in addition to further determinations, e.g., the controller or central device determining if it is appropriate to authenticate the requesting device. A procedure such as a four-way-handshake may be performed to complete an RSNA or other authentication setup. This procedure may involve several transmissions back and forth between the devices.

In operation 530, the controller or central device may set or change a state variable representing the requesting device to indicate that the device is authenticated. In some embodiments this corresponds with state 3 in FIG. 3. A state variable stored within the controller or central device may be set or changed indicating that the requesting device (or a process in the requesting device) is authenticated with the controller or central device.

In operation 540, the requesting device may similarly set or change a state variable representing the requesting device (e.g., a STA such as device 100) to indicate that the requesting device (or a process, identifier, or MAC address) is authenticated (e.g., RSNA established).

Other operations or series of operations may be used.

Frames or transmissions other than or additional to those described herein may be sent as known in the art to establish association or authentication (e.g., acknowledgement frames). While in the embodiments shown in FIGS. 4 and 5 pairs of devices become associated and unassociated, in other embodiments of the present invention more than two devices may associate and/or authenticate with each other.

In the various embodiments discussed, the operations of setting the values, or establishing state variables, indicating a change of state to an associated and/or authenticated state, in each device, may be performed at various times depending on the embodiment. For example, variables may be established or set before, contemporaneous with, or after the sending of frames requesting, accepting or acknowledging a request. Therefore in some embodiments, each of a device A and a device B, attempting to associate, disassociate, authenticate or un-authenticate, may hold state variables that do not match either each other or the actual state, for some (typically brief) amount of time.

Some embodiments of the invention may be implemented, for example, using a machine-readable medium or article which may store an instruction or a set of instructions that, if executed by a machine, cause the machine to perform a method and/or operations in accordance with embodiments of the invention. Such a machine may include, for example, any suitable computing or processing platform or device, computer, processor, or the like, and may be implemented using any suitable combination of hardware and/or software. The machine-readable medium or article may include, for example, any suitable type of memory or storage unit, medium, article or device (e.g. a memory 114, memory 140, or storage device 145). The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, assembly language, machine code, or the like.

Although the subject matter has been described with specific language and structural features, it is to be understood that the subject matter defined in the appended claims is not necessarily limited to the specific features or acts described above. Rather, the specific features and acts described above are disclosed as examples of implementing the claims.

1. A method comprising:
at a first wireless device, receiving a message from a second wireless device requesting to associate with the first wireless device, wherein the second wireless device is unassociated and unauthenticated with the first wireless device;
at the first wireless device, storing a state variable to indicate that the second wireless device is associated and unauthenticated with the first wireless device;
at the first wireless device, receiving a message from the second wireless device requesting to establish authentication; and
at the first wireless device, changing the state variable to indicate that the second wireless device is authenticated with the first wireless device.

2. The method of claim 1, wherein the state variable comprises a first variable indicating whether or not the second wireless device is associated or unassociated and a second variable indicating whether the second device is unauthenticated with the first wireless device or authenticated with the first wireless device.

3. The method of claim 1, comprising, when the second wireless device is unassociated and unauthenticated with the first wireless device, the first wireless device transmitting information of a first security level to the second wireless device; and
when the second wireless device is associated and unauthenticated with the first wireless device, the first wireless device transmitting information of a second security level to the second wireless device, the second security level being higher than the first security level.

4. The method of claim 3, comprising, when the second wireless device is authenticated with the first wireless device, the first wireless device transmitting information of a third security level to the second wireless device, the third security level being higher than the second security level.

5. The method of claim 1, wherein the message from the second wireless device requesting to establish authentication is a message to establish RSNA authentication.

6. The method of claim 1, wherein the first wireless device and the second wireless device communicate via radio frequency.

7. The method of claim 1, wherein the first wireless device is a PBSS central point (PCP).

8. The method of claim 1, wherein the state variable indicates whether a first process executed by the second wireless device is unauthenticated or authenticated with the first wireless device, the method comprising, at the first wireless device, receiving a message from the second wireless device requesting to establish authentication regarding a second process executed by the second wireless device; and at the first wireless device, changing a second state variable to indicate that the second process is authenticated with the first wireless device.

9. A method comprising:
at a first wireless device, receiving a message from a second wireless device requesting to establish RSNA, wherein the second wireless device is unassociated and RSNA un-established with the first wireless device; and
at the first wireless device, storing a plurality of state variables indicating the association status of the second wireless device with the first wireless device and indicating that the second wireless device is RSNA established with the first wireless device.

10. The method of claim 9, comprising, when the second wireless device is unassociated and unauthenticated with the first wireless device, the first wireless device transmitting information of a first security level to the second wireless device; and
when the second wireless device is authenticated with the first wireless device, the first wireless device transmitting information of a second security level to the second wireless device, the second security level being higher than the first security level.

11. The method of claim 9, wherein the message from the second wireless device requesting to establish authentication is a message to establish RSNA authentication.

12. The method of claim 9, wherein the first wireless device and the second wireless device communicate via radio frequency.

13. A wireless device comprising:
a processor;
a memory;
a transmitter; and
a receiver;
wherein the processor is to, when at the wireless device a message is received from a second wireless device requesting to associate with the wireless device, wherein second wireless device is unassociated and unauthenticated with the wireless device, store a state variable to indicate that the second wireless device is associated and unauthenticated with the first wireless device; and
wherein the processor is to, when, at the wireless device, a message is received from the second wireless device requesting to establish authentication, change the state variable to indicate that the second wireless device is authenticated with the wireless device.

14. The device of claim 13, wherein the state variable comprises a first variable indicating whether or not the second wireless device is associated or unassociated and a second variable indicating whether the second device is unauthenticated with the wireless device or authenticated with the wireless device.

15. The device of claim 13, wherein, when the second wireless device is unassociated and unauthenticated with the first wireless device, the processor causing to be transmitted information of a first security level to the second wireless device; and
when the second wireless device is associated and unauthenticated with the wireless device, the processor causing to be transmitted information of a second security level to the second wireless device, the second security level being higher than the first security level.

16. The device of claim 15, wherein, when the second wireless device is authenticated with the wireless device, the processor causing to be transmitted information of a third security level to the second wireless device, the third security level being higher than the second security level.

17. The device of claim 13, wherein the message from the second wireless device requesting to establish authentication is a message to establish RSNA authentication.

18. The device of claim 13, wherein the first wireless device and the second wireless device communicate via radio frequency.

19. The device of claim 13, comprising:
a second processor; and
a network adapter which includes the processor and memory.

20. The device of claim 13, comprising an antenna.

21. A wireless device comprising:
a processor;
a memory;
a transmitter; and
a receiver;
wherein the processor is to, when, at the wireless device, a message is received from a second wireless device requesting to establish authentication, the second wireless device being unassociated and unauthenticated with the wireless device, store a state variable indicating that the second wireless device is associated or unassociated with the wireless device and that the second wireless device is authenticated with the wireless device.

22. The device of claim 21, wherein, when the second wireless device is unassociated and unauthenticated with the first wireless device, the processor causing to be transmitted information of a first security level to the second wireless device; and
when the second wireless device is authenticated with the wireless device, the processor causing to be transmitted information of a third security level to the second wireless device, the third security level being higher than the second security level.

23. The device of claim 21, wherein the message from the second wireless device requesting to establish authentication is a message to establish RSNA authentication.

24. The device of claim 21, comprising:
a second processor; and
a network adapter which includes the processor and memory.

25. The device of claim 21, comprising an antenna.
